(19) United States
(12) Patent Application Publication
(10) Pub. No.: US 2007/0206217 A1
(43) Pub. Date: Sep. 6, 2007

(54) Printer device

(76) Inventor: Akeo Maruyama, Tokyo (JP)

Correspondence Address: HARNESS, DICKEY & PIERCE, P.L.C., P.O. BOX 8910, RESTON, VA, 20195, US

(21) Appl. No.: 11/711,607

(22) Filed: Feb. 28, 2007

(30) Foreign Application Priority Data
Mar. 1, 2006 (JP) 2006-054402
Jan. 24, 2007 (JP) 2007-013909

(51) Int. Cl. G06F 3/12

(52) U.S. Cl. 358/1.15

(57) ABSTRACT

A printer device is disclosed that is able to appropriately acquire information necessary for a network printer driver installed in a host device. The printer device is used in a network printer system in which the printer device is connected to plural host devices through a network, and the printer device outputs printed materials corresponding to printing information created by the host devices. The printer device includes an information generation procedure storage unit for storing plural information generation procedures in connection with type information of the host devices; a response information formation unit for receiving the type information, retrieving the information generation procedure corresponding to the received type information from the information generation procedure storage unit, and converting the device information of the printer device to response information by applying the retrieved information generation procedure; and an information transmission unit for transmitting the response information to the host devices.

### BACKGROUND OF THE INVENTION

1. Field of the Invention

The present invention relates to a printer device of a network printer system in which the printer device is connected, through a network, to plural host devices for creating printing information, and the printer device outputs printed materials corresponding to the printing information created by the host devices.

2. Description of the Related Art

In the related art, in a network printer system in which a printer device is connected, through a network, to plural host devices for creating printing information, and the printer device outputs printed materials corresponding to the printing information created by the host devices, in response to a query from a printer driver of a network printer, which printer driver is installed in one of the host devices, the printer device transmits response information (also referred to as “printer device function information”) to the host device, which information indicates functions and performances of the printer device itself. Based on the received response information, the printer driver of the network printer in the host device is able to display an image on its screen for a user to appropriately select a function. For example, Japanese Laid-Open Patent Application No. 2003-099228 (hereinafter, referred to as “reference 1”) and Japanese Laid-Open Patent Application No. 2000-099286 (hereinafter, referred to as “reference 2”) disclose techniques in this field.

However, in the related art, if the printer device does not return all of the information necessary to the network printer driver in the host device, or if the form of the information sent from the printer device is not supported by the network printer driver in the host device, the network printer driver cannot perform operations appropriately.

For example, for an old printer device which was fabricated sometime before, in response to a query of a printing function on a network, for example, the printer device can only make a response concerning whether stapling of the printed materials function is allowed. On the other hand, for a recent network printer driver in the host device, for example, if the information of stapling positions is also required, with only information whether stapling is allowed, the network printer driver in the host device cannot provide a user with an appropriate image on its screen for operations of the user.

In addition, the old printer device responds concerning whether stapling of the printed materials function is allowed in a specified form. On the other hand, the recent network printer driver in the host device sometimes needs to respond to a user in different forms, and in this case, the recent network printer driver in the host device cannot obtain the information concerning whether stapling is allowed, and the network printer driver in the host device cannot provide the user with an appropriate image for setting the stapling function.

### SUMMARY OF THE INVENTION

An embodiment of the present invention may solve one or more problems of the related art.

A preferred embodiment of the present invention may provide a printer device able to appropriately acquire information necessary for a network printer driver installed in a host device.

According to an aspect of the present invention, there is provided a printer device of a network printer system wherein the printer device is connected to plural host devices for creating printing information through a network, and the printer device outputs printed materials corresponding to the printing information created by the host devices, said printer device comprising:

an information generation procedure storage unit that stores a plurality of information generation procedures in connection with type information of the host devices, each of said information generation procedures being applied when converting device information of the printer device to response information interpretable by the host devices;

a response information formation unit that receives the type information of the host devices, retrieves the information generation procedure stored in the information generation procedure storage unit in correspondence to the received type information, and converts the device information of the printer device to the response information by applying the retrieved information generation procedure; and

an information transmission unit that transmits the response information formed by the response information formation unit to the host devices.

As an embodiment, the host devices create image data to be displayed based on the received response information for a user to perform printing operations.

As an embodiment, when the information generation procedures corresponding to the type information sent from the host devices are not stored in the printer device, the printer device receives the information generation procedures corresponding to the type information from the host devices.

As an embodiment, when the information generation procedures corresponding to the type information sent from the host devices are not stored in the printer device, the printer device transmits the device information to the host devices.

As an embodiment, a server device is provided in the network, said server device having an information generation procedure storage unit for storing plural of the information generation procedures in connection with the type information of the host devices,

when receiving the type information sent from the host devices, the printer device acquires the information generation procedures in correspondence to the received type information from the server device, converts the device information of the printer device to the response information by applying the acquired information generation procedure, and transmits the response information to the host devices.

According to the present invention, since information necessary for a network printer driver installed in a host device can be appropriately created to respond to the host device, it is possible to perform printing appropriately by using the printer device.

These and other objects, features, and advantages of the present invention will become more apparent from the following detailed description of preferred embodiments given with reference to the accompanying drawings.

### BRIEF DESCRIPTION OF THE DRAWINGS

FIG. 1 is a block diagram illustrating a network printer system according to an embodiment of the present invention;

FIG. 2 is a block diagram illustrating a configuration of the printer device PT;

FIG. 3 is a block diagram illustrating a configuration of the host device HT (HT1 or HT2);

FIG. 4A is a schematic view of an initial user interface (UI) screen of the printer driver;

FIG. 4B is a schematic view of a user interface screen displayed when the operation tab TB2 is selected;

FIG. 5A is a schematic view of a user interface screen for selecting the print paper;

FIG. 5B is a schematic view of a user interface screen with newly added items;

FIG. 6A is a schematic view of a user interface screen with extended functions displayed for a network printer driver of the type A;

FIG. 6B is a schematic view of a user interface screen with newly added extended functions for a network printer driver of the type A;

FIG. 7A is a schematic view of a user interface screen with extended functions displayed for a network printer driver of the type B;

FIG. 7B is a schematic view of a user interface screen with newly added extended functions for a network printer driver of the type B;

FIG. 8A is a table illustrating an example of the information sent to the network printer driver of type A;

FIG. 8B is a table illustrating an example of the print paper specification table for the network printer driver of type A;

FIG. 8C is a table illustrating an example of the selection specification table for the network printer driver of type A;

FIG. 9A is a table illustrating an example of the information sent to the network printer driver of type B;

FIG. 9B is a table illustrating an example of the print paper specification table for the network printer driver of type B;

FIG. 10 is a diagram illustrating operations of the printer device PT for converting registered printer device information D1 of various device functions of the printer device PT to the response information D3 interpretable by the network printer driver by applying specified information generation procedure D2;

FIG. 11 illustrates an example of an information generation procedure table including the type information of the network printer drivers and the corresponding information generation procedures;

FIG. 12 is a block diagram illustrating a principal portion of a software configuration of the printer device PT;

FIG. 13 is a block diagram illustrating a software configuration for printing operations in the host device HT;

FIG. 14 is a flowchart illustrating principal operations of the network printer driver in the host device HT during a printing process;

FIG. 15 is a flowchart illustrating principal operations of the printer device PT;

FIG. 16 is a flowchart illustrating principal operations of the network printer driver in the host device HT during a printing process when the information generation procedures are stored in the host device HT;

FIG. 17 is a flowchart illustrating principal operations of the printer device PT when the information generation procedures are stored in the host device HT;

FIG. 18 is a flowchart illustrating principal operations of the network printer driver in the host device HT during a printing process when the response information is created in the host device HT;

FIG. 19 is a flowchart illustrating principal operations of the printer device PT when the response information is created in the host device HT;

FIG. 20 is a block diagram illustrating a network printer system according to another embodiment of the present invention;

FIG. 21 is a block diagram illustrating a configuration of the server device SV;

FIG. 22 is a flowchart illustrating principal operations of the printer device PT in the network printer system as shown in FIG. 20;

FIG. 23 is a flowchart illustrating an example of operations of the server device SV in the network printer system as shown in FIG. 20;

FIG. 24 is a flowchart illustrating an example of operations of the printer device PT in the network printer system as shown in FIG. 20 with the information generation procedure table being updated at any time;

FIG. 25 is a flowchart illustrating an example of operations of the server device SV when the host device HT registers the information generation procedure corresponding to itself in the server device SV;

FIG. 26 is a table illustrating an example of a response information table stored in the server device SV;

FIG. 27 is a flowchart illustrating an example of operations of the printer device PT for sending the response information to the server device SV;

FIG. 28 is a flowchart illustrating an example of operations of the server device SV for storing the response information in the server device SV;

FIG. 29 is a flowchart illustrating an example of operations of the printer device PT in the present example when receiving the type information from the network printer driver of any one of the host devices HT; and

FIG. 30 is a flowchart illustrating an example of operations of the server device SV in the present example corresponding to the operations of the printer device PT in FIG. 29.

### DESCRIPTION OF THE PREFERRED EMBODIMENTS

Below, preferred embodiments of the present invention are explained with reference to the accompanying drawings.

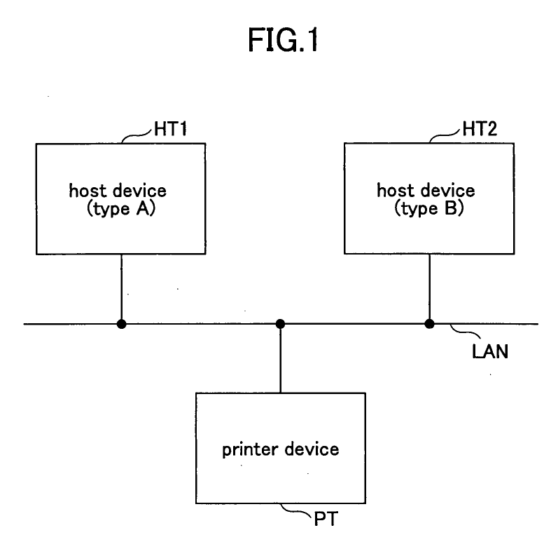

FIG. 1 is a block diagram illustrating a network printer system according to an embodiment of the present invention.

As shown in FIG. 1, two host devices HT1, HT2 are connected to a printer device PT through a network, such as a Local Area Network (LAN). Namely, the printer device PT is a printer able to be used through a network (below, referred to as a “network printer”). Software is installed in the host devices HT1 and HT2, for example, application software for creating printing information, a network printer driver for transmitting printing jobs to the printer device PT through the Local Area Network (LAN), and so on.

The printer device PT records and outputs printed materials corresponding to the printing jobs received from the host devices HT1 and HT2 through the Local Area Network (LAN). In addition, the printer device PT and the host devices HT1, HT2 exchange various kinds of information when necessary.

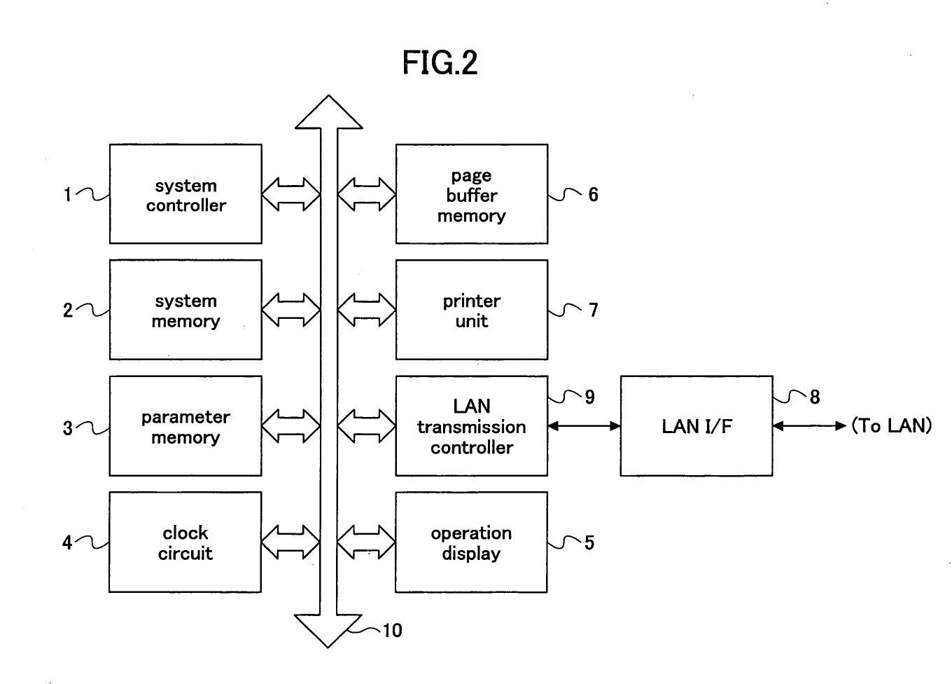

FIG. 2 is a block diagram illustrating a configuration of the printer device PT.

As shown in FIG. 2, the printer device PT includes a system controller 1, a system memory 2, a parameter memory 3, a clock circuit 4, an operations display 5, a page buffer memory 6, a printer unit 7, a Local Area Network interface (LAN I/F) 8, a Local Area Network transmission controller 9, and an internal bus 10.

The system controller 1 controls operations of components of the printer device PT, paper feeding operations, printing operations, communications with external devices through a communication unit, and user's operations via a user interface when a user operates the printer device PT, and other various kinds of operations.

The system memory 2 stores various control programs executed by the system controller 1, and provides a working area of the system controller 1.

The parameter memory 3 stores various device information specific to the printer device PT.

The clock circuit 4 outputs the current time.

The operations display 5 constitutes an interface for a user to operate the printer device PT.

The page buffer memory 6 constitutes a frame memory for storing printing data equivalent to one page.

The printer unit 7 retrieves the printing data from the frame memory formed by the page buffer memory 6, and prints images on a manuscript.

The Local Area Network interface 8 connects the printer device PT to a Local Area Network (LAN).

The Local Area Network transmission controller 9 executes communication control for various protocol suites, which are used for exchanging various kinds of data with other printer terminal devices.

The system memory 2, the parameter memory 3, the clock circuit 4, the operations display 5, the page buffer memory 6, the printer unit 7, the Local Area Network interface (LAN I/F) 8, and the Local Area Network transmission controller 9 are all connected to the internal bus 10, and data exchanges between the above components are performed primarily through the internal bus 10.

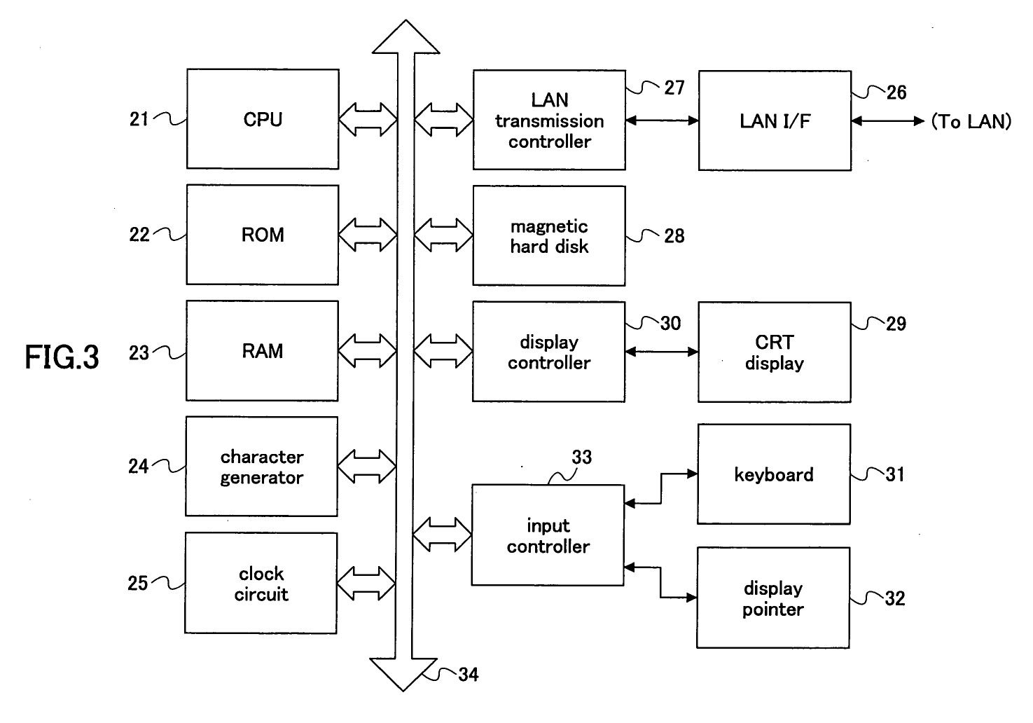

FIG. 3 is a block diagram illustrating a configuration of the host device HT (HT1 or HT2).

As shown in FIG. 3, the host device HT includes a Central Processing Unit (CPU) 21, a Read-Only Memory (ROM) 22, a Randomly-Access Memory (RAM) 23, a character generator 24, a clock circuit 25, a Local Area Network interface (LAN I/F) 26, a Local Area Network transmission controller 27, a magnetic hard disk device 28, a Cathode Ray Tube (CRT) display 29, a display controller 30, a keyboard 31, a display pointer 32, an input controller 33, and a bus line 34.

The CPU 21 controls operations of the host device HT.

The ROM 22 stores various programs executed and data required when the CPU 21 is initiated.

The RAM 23 constitutes a working area of the CPU 21.

The character generator 24 generates representation data of graphic characters.

The clock circuit 25 outputs the current time.

The LAN I/F 26 connects the host device HT to a Local Area Network (LAN).

The LAN transmission controller 27 executes communication control for various protocol suites, which are used for exchanging various kinds of data with other data terminal devices.

The magnetic hard disk device 28 stores various application programs such as word processing software, system software such as network printer drivers, and various kinds of data such as work data, file data, and image data.

The CRT display 29 displays an image on its screen for operating the host device HT.

The display controller 30 controls the contents displayed by the CRT display 29.

The keyboard 31 allows various key operations for the host device HT.

The display pointer 32 is able to determine any position on the CRT display 29 so as to perform operations at specified positions.

The input controller 33 reads input information from the keyboard 31 and the display pointer 32.

The CPU 21, the ROM 22, the RAM 23, the character generator 24, the clock circuit 25, the LAN I/F 26, the LAN transmission controller 27, the magnetic hard disk device 28, the CRT display 29, the display controller 30, the keyboard 31, the display pointer 32, and the input controller 33 are all connected to the bus line 34, and data exchanges between the above components are performed primarily through the bus line 34.

In the present embodiment, network printer drivers are installed in the host devices HT1 and HT2 for transmitting printing jobs to the printer device PT through the Local Area Network (LAN), or transmitting appropriate commands to the printer device PT, or allowing a user to specify the commands to be transmitted to the printer device PT.

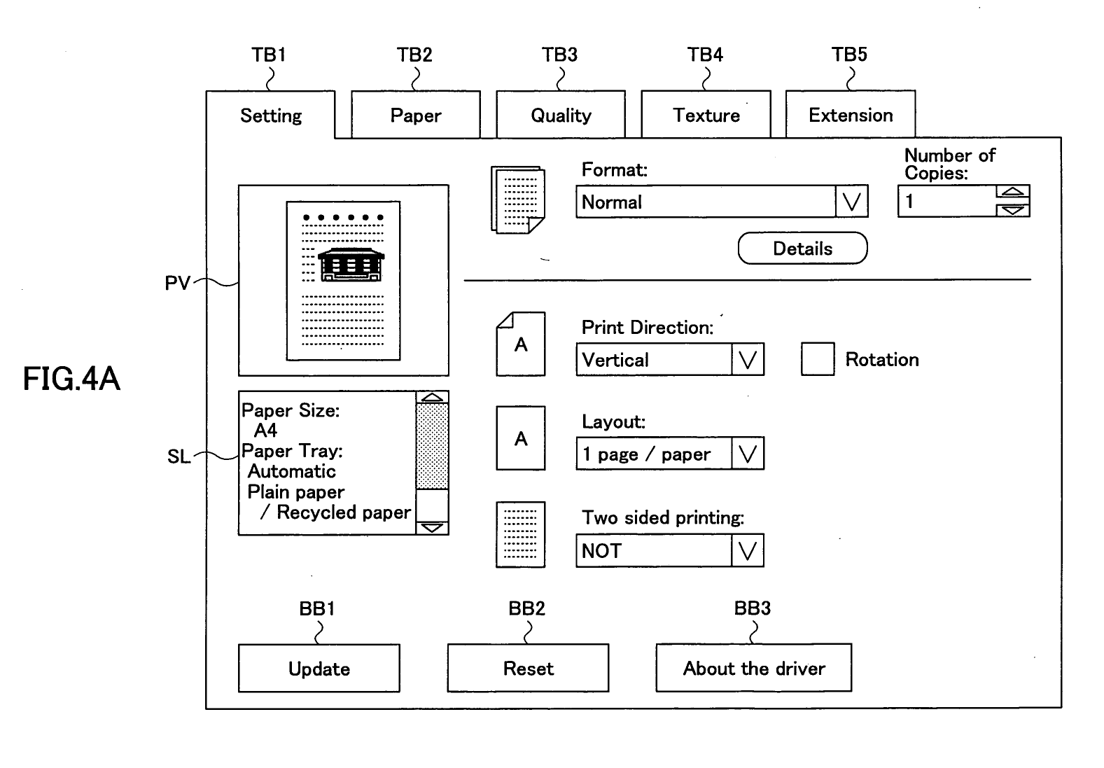

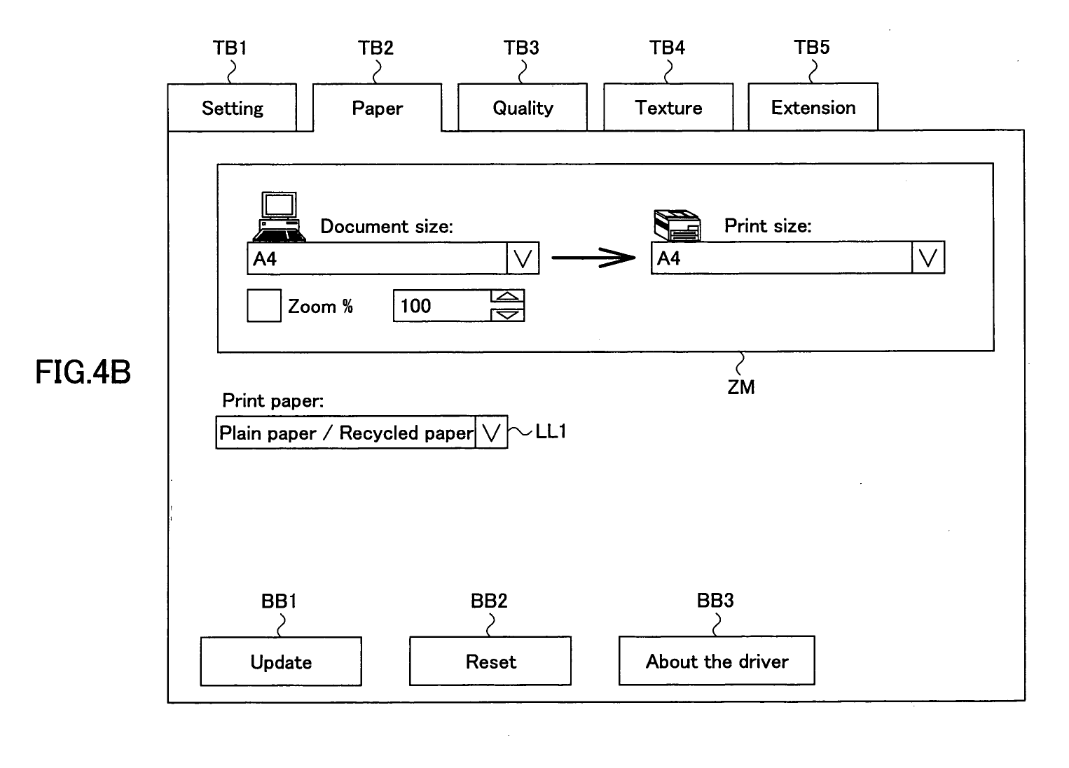

FIG. 4A is a schematic view of an initial user interface (UI) screen of the printer driver.

By the network printer drivers, a user interface (UI) image as shown in FIG. 4A is displayed on a screen to present various items of user operations so that a user can select and transmit a desired command to the printer device PT. For example, the displayed items as shown in FIG. 4A include whether various functions of the printer device PT are utilized, how to utilize the device functions, what kinds of options are to be specified, how to designate the number of copies to be printed, or how to designate the page to be printed.

For example, in the user interface screen shown in FIG. 4A, there are five operational tabs TB1, TB2, TB3, TB4, and TB5. The user clicks the tabs TB1, TB2, TB3, TB4, and TB5 to display a setting screen, a paper setting screen, a printing quality setting screen, a texture setting screen, and an extended function setting screen, respectively.

The user interface screen shown in FIG. 4A is an initial user interface screen; the tab TB1 is clicked, and thereby the setting screen is displayed. In the setting screen, a window PV displays an example of a printing completed according to current settings; a window SL displays a list of the current settings.

On this UI screen, the user can set the printing style, the number of copies, the printing direction, layout, and enable or disable two-sided printing.

Common buttons BB1, BB2, BB3, which are common to the paper setting screen, the printing quality setting screen, the texture setting screen, and the extended function setting screen, are displayed in the lower portion of the UI screen. Specifically, the button BB1 is used for updating the device information of the printer device PT. The button BB2 is used for resetting the current settings to the original one, namely, reset the current settings to default values.

The button BB3 is used for displaying the name or version of the network printer driver.

FIG. 4B is a schematic view of a user interface screen displayed when the operation tab TB2 is selected.

In the user interface screen shown in FIG. 4B, there are a zone ZM for setting a scaling factor of a printing size relative to a document size, and a drop down list LL1 for selecting print paper.

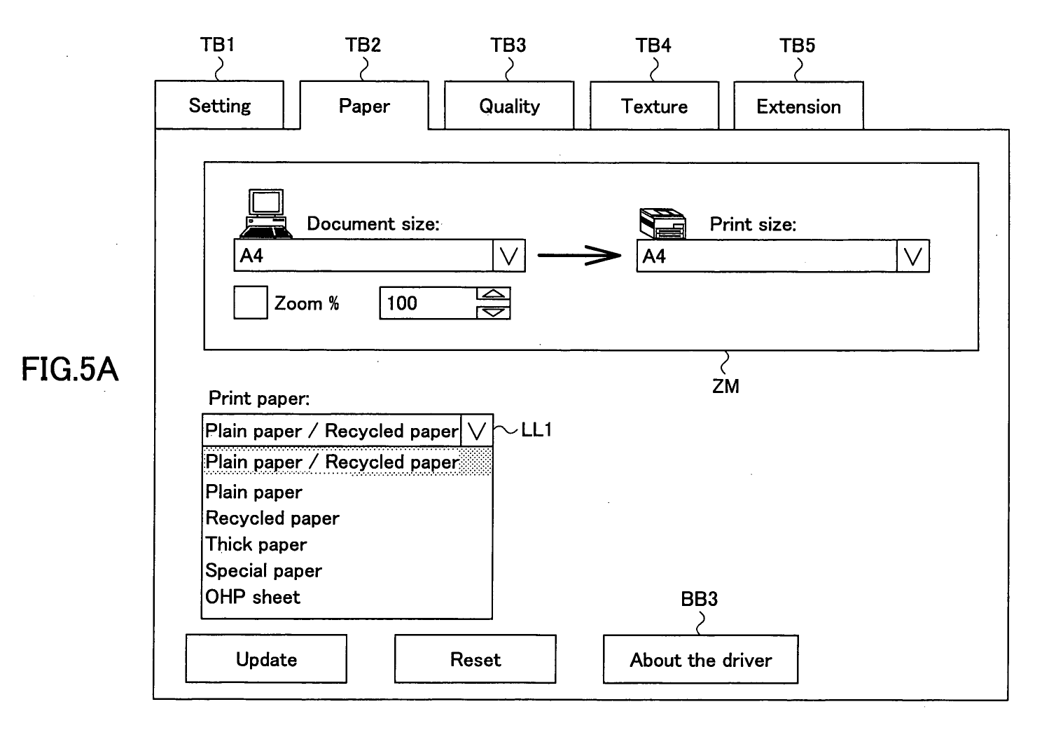

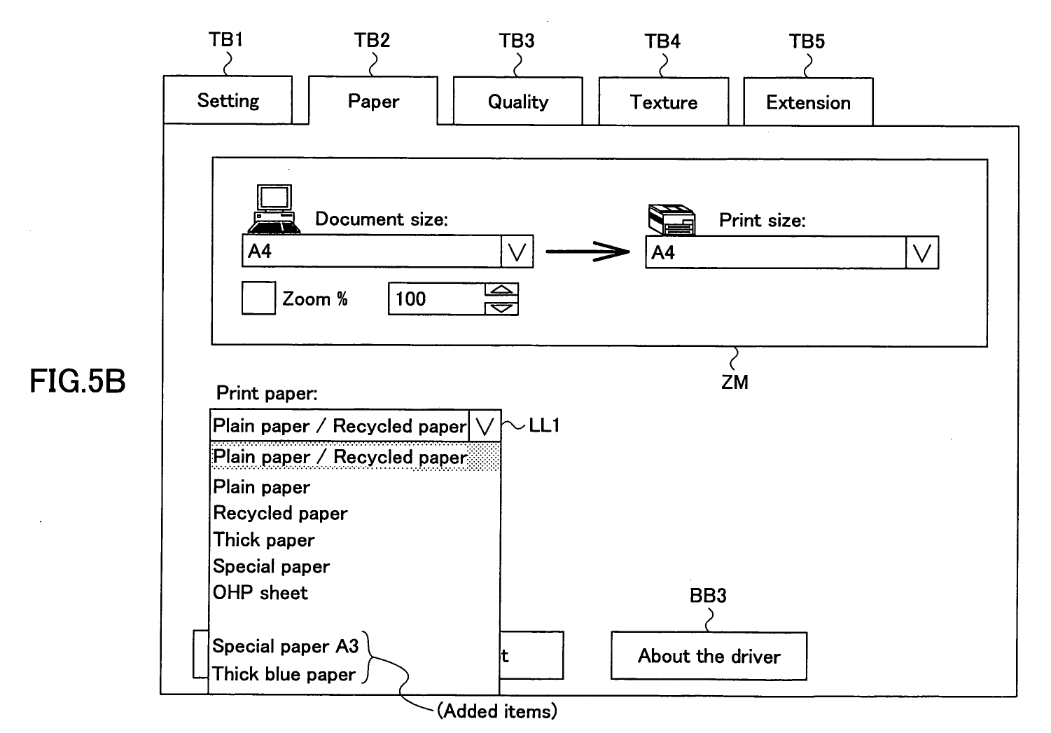

FIG. 5A is a schematic view of a user interface screen for selecting the print paper.

When clicking the right end of the drop down list LL1 in FIG. 4B, a list of types of print paper available in the printer device PT is displayed, as shown in FIG. 5A, and the current setting is highlighted (shaded in FIG. 5A), and is located at the top of the list. By shifting the highlighted item downward, the desired type of print paper is selected.

FIG. 5B is a schematic view of a user interface screen with newly added items.

In FIG. 5A, when the button BB1 is clicked, the network printer driver requests the printer device PT to provide the printer device information. Here, for example, assume the user desires to add two types of paper, “special paper A3” and “thick blue paper”, to the list of the types of print paper available to the printer device PT, then information reporting that the newly added two types of paper are included in the printer device information received from the printer device PT (this process is described below in detail), and as a result, as shown in FIG. 5B, new items are added to the end of the current items of the drop-down list LL1.

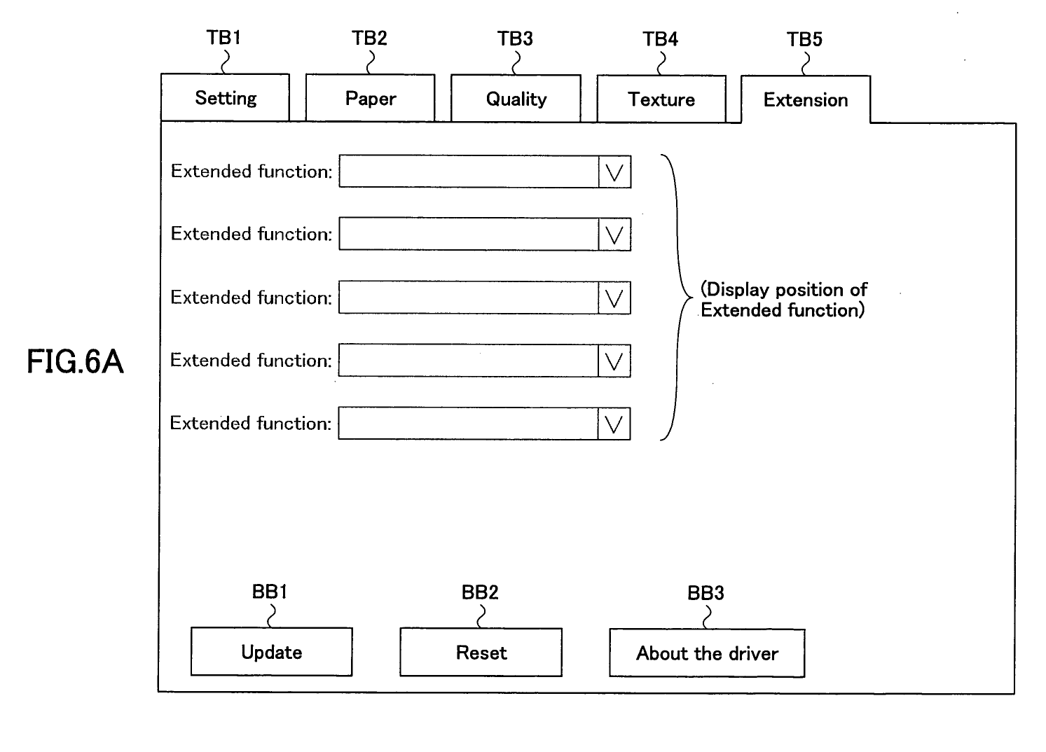

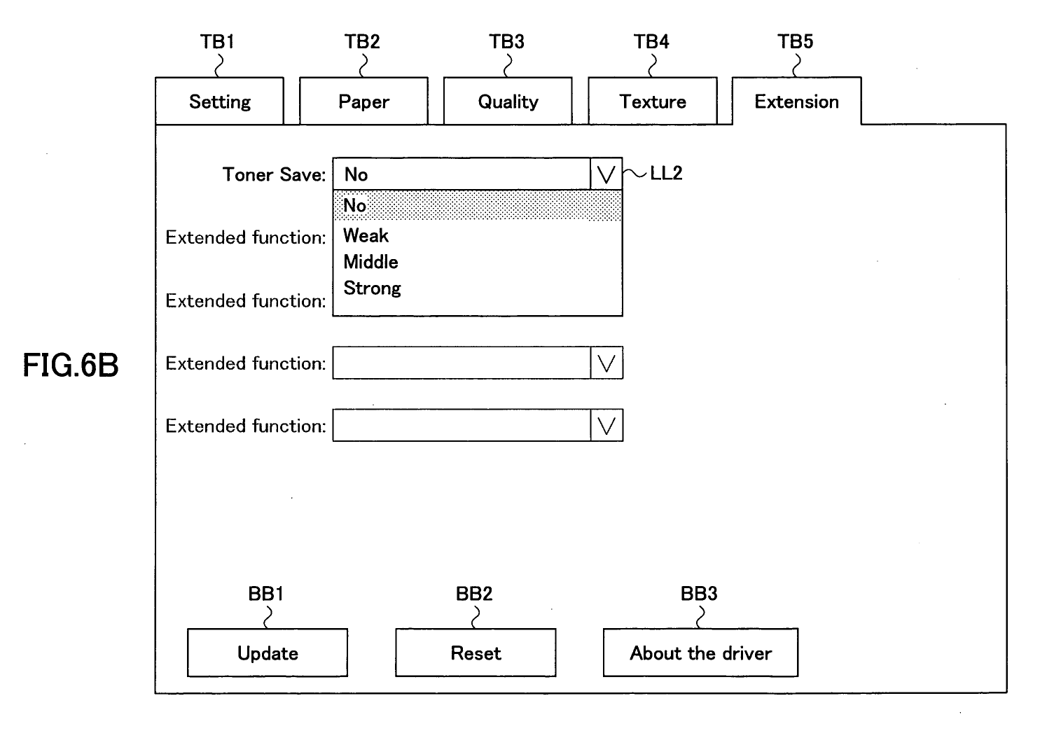

FIG. 6A is a schematic view of a user interface screen with extended functions displayed for a network printer driver of the type A.

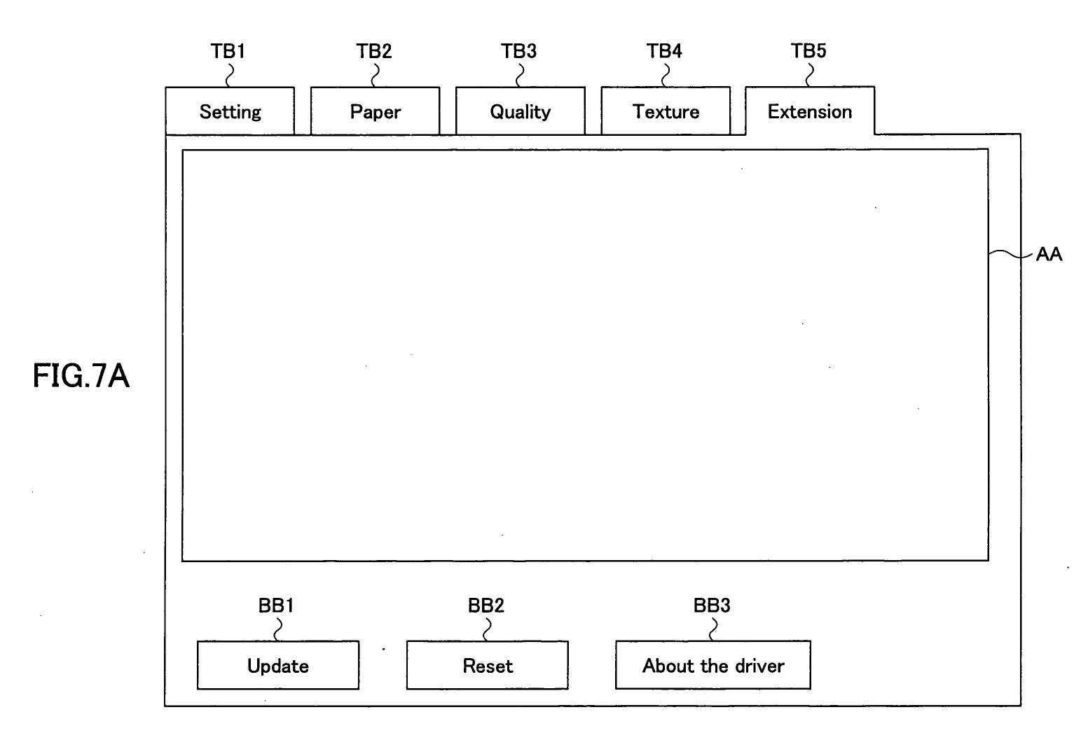

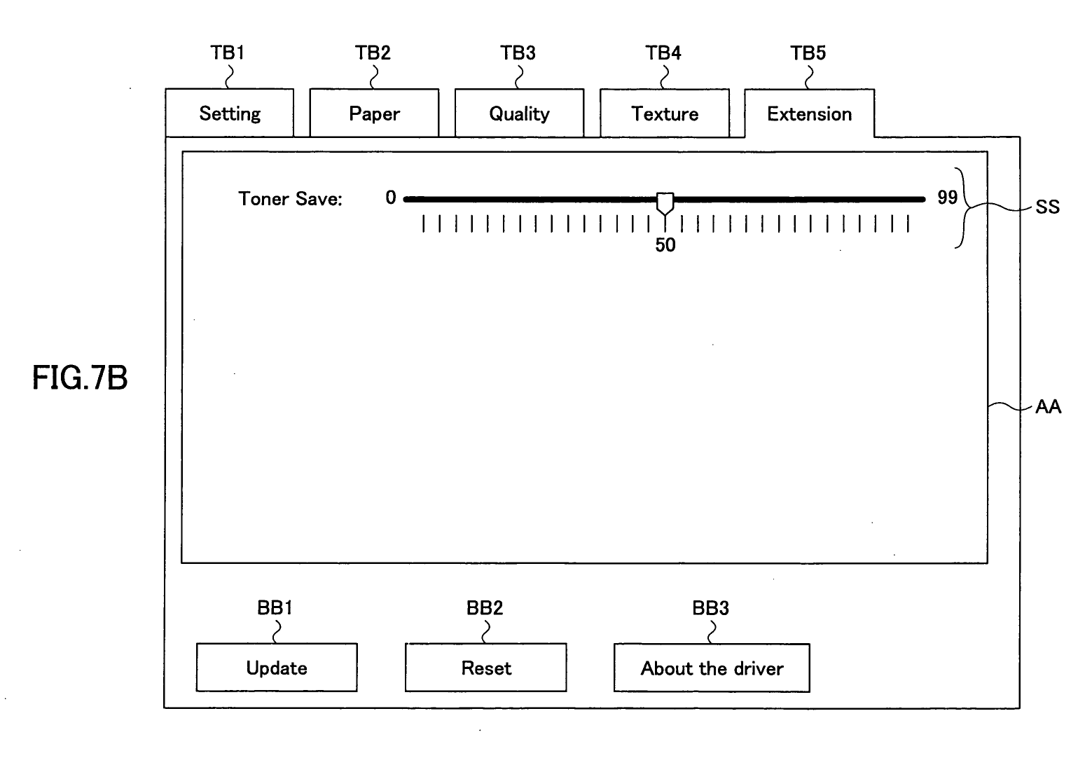

FIG. 7A is a schematic view of a user interface screen with extended functions displayed for a network printer driver of the type B.

In FIG. 6A and FIG. 7A, the tab TB5 is clicked, and the extended function setting screen is displayed.

For example, the extended function setting screen in FIG. 6A is a user interface screen for a network printer driver of the type A, which is installed in the host device HT1, and is at a time prior to acquisition of the printer device information from the printer device PT.

The extended function setting screen in FIG. 7A is a user interface screen for a network printer driver of the type B, which is installed in the host device HT2, and is at a time prior to acquisition of the printer device information from the printer device PT.

In the extended function setting screen in FIG. 6A, drop-down lists are used to select respective extended functions.

FIG. 6B is a schematic view of a user interface screen with newly added extended functions for a network printer driver of the type A.

For example, assume the printer device PT has an extended function of “Toner Save”; as described above, when the printer device information is received from the printer device PT, information of the extended function “Toner Save” is included in the received printer device information; thus as shown in FIG. 6B, an operational item “Toner Save” is displayed by a drop-down list LL2, and the user can select one item from the drop-down list LL2.

In the extended function setting screen in FIG. 7A, operational items of the extended functions are displayed in a region AA.

FIG. 7B is a schematic view of a user interface screen with newly added extended functions for a network printer driver of the type B.

For example, assume the printer device PT has the extended function of “Toner Save”. As described above, when the printer device information is received from the printer device PT, information of the extended function “Toner Save” is included in the received printer device information; thus as shown in FIG. 7B, an operational item “Toner Save” is displayed in the region AA. In FIG. 7B, the operational item “Toner Save” is displayed with a slider SS, and a sliding member 50 (a downward arrow in FIG. 7B) of the slider SS is moved in the horizontal direction to appropriately adjust the percentage of the Toner Save function in the integer range from 0 to 99.

Since the way of displaying various functions, such as the extended functions, are predetermined according to the type of the network printer driver installed in the host device HT, when the printer device PT transmits the printer device information to the network printer driver, it is necessary to represent these functions in forms able to be dealt with by the respective network printer drivers.

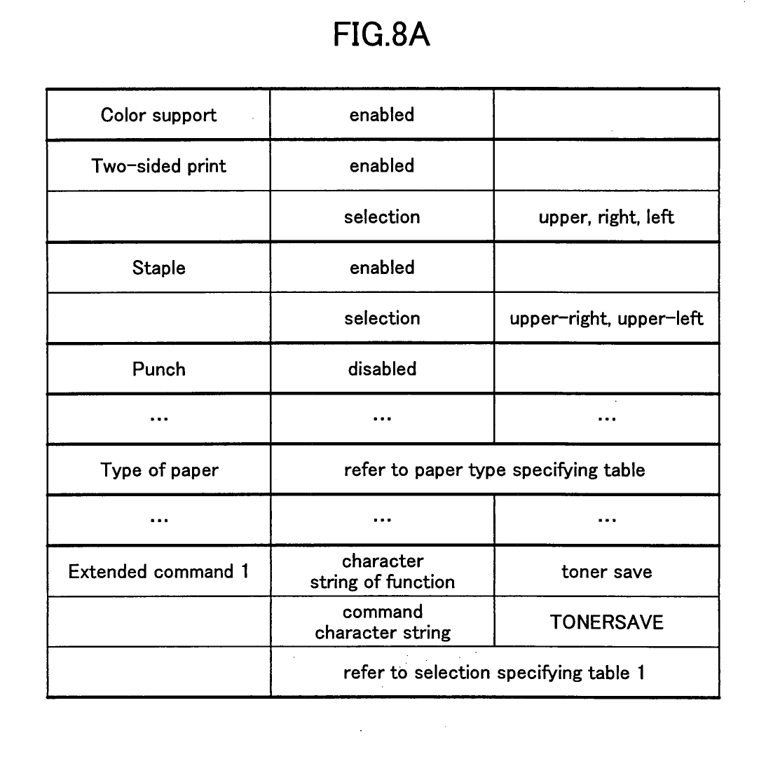

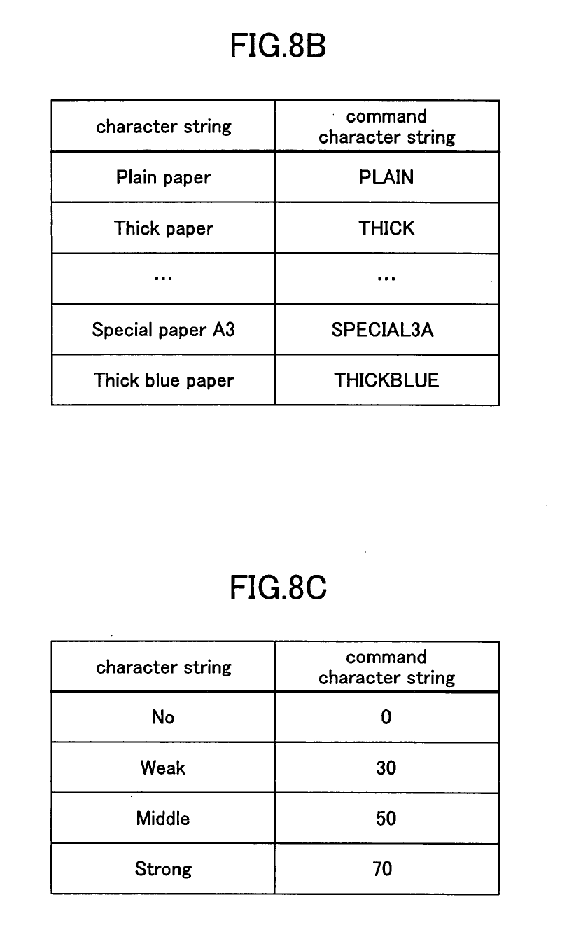

For example, information in the form as shown in FIG. 8A can be sent to the network printer driver of type A.

FIG. 8A is a table illustrating an example of the information sent to the network printer driver of type A.

It is shown in FIG. 8A that a print paper specification table should be referred to for selection of types of the print paper.

FIG. 8B is a table illustrating an example of the print paper specification table for the network printer driver of type A.

Since it is described in FIG. 8A that the print paper specification table should be referred to, the print paper specification table shown in FIG. 8B should also be transmitted.

In the print paper specification table, values of a quantity “character string” and values of a quantity “command character string” are stored in pairs. Here, the “character string” represents types of paper, and the “command character string” represents command values sent to the printer device PT when a certain type of paper is selected.

In FIG. 8A, concerning a quantity “extended command 1”, which is used as an extended function, a value “toner save” is assigned to a quantity “character string of function” to represent the extended function, and a string “TONERSAVE” is assigned to the quantity “command character string”, which is used to instruct the printer device PT of the extended function.

In FIG. 8A, it is shown that a selection specification table 1 should be referred to in determining the method of designating the above values.

FIG. 8C is a table illustrating an example of the selection specification table for the network printer driver of type A.

Since it is stated in FIG. 8A that the selection specification table 1 should be referred to, the selection specification table should also be transmitted.

In the selection specification table, values of a quantity “character string” and values of a quantity “command character string” are stored in pairs. Here, the “character string” represents the items when the extended functions are displayed as the drop down list LL2 on the user interface screen, and the “command character string” represents command values to be sent to the printer device PT when a certain item is selected.

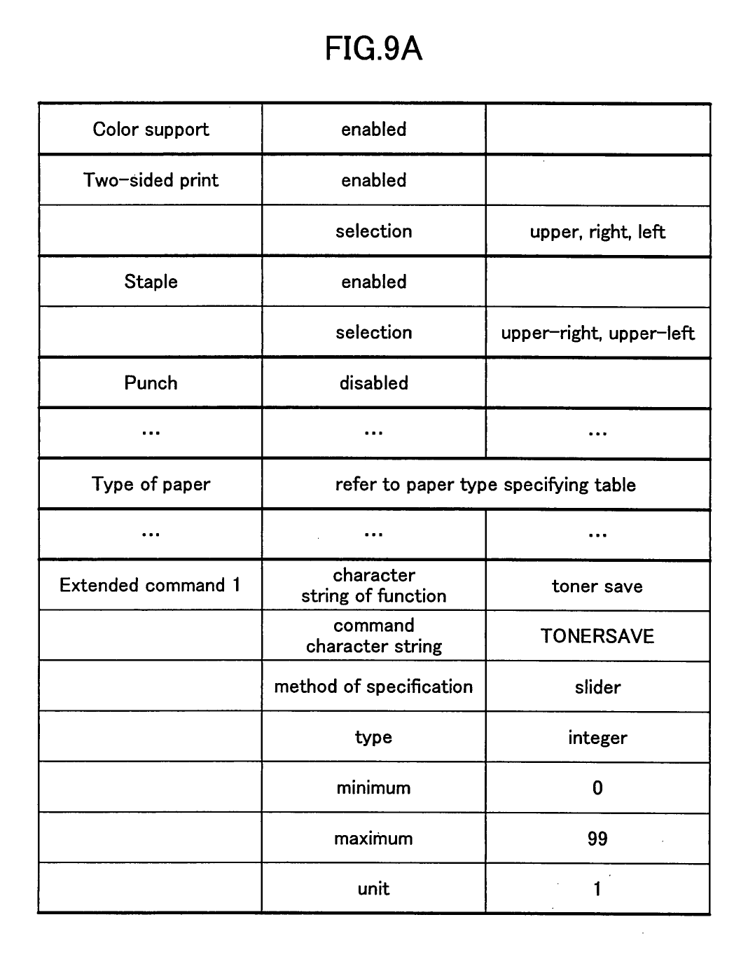

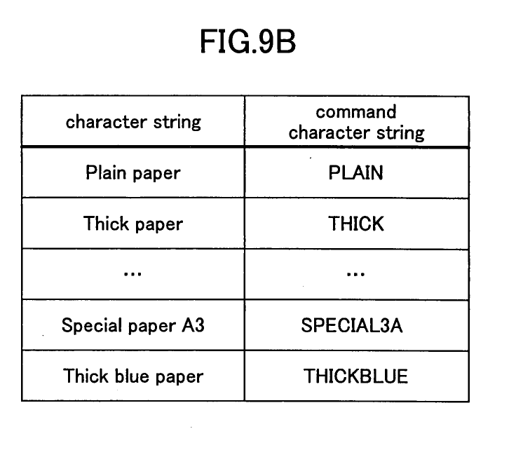

FIG. 9A is a table illustrating an example of the information sent to the network printer driver of type B.

It is shown in FIG. 9A that a print paper specification table should be referred to for selection of types of the print paper.

FIG. 9B is a table illustrating an example of the print paper specification table for the network printer driver of type B.

Since it is described in FIG. 9A that the print paper specification table should be referred to, the print paper specification table shown in FIG. 9B should also be transmitted.

In the print paper specification table, values of a quantity “character string” and values of a quantity “command character string” are stored in pairs. Here, the “character string” represents types of paper, and the “command character string” represents command values to be sent to the printer device PT when a certain type of paper is selected.

In FIG. 9A, concerning a quantity “extended command 1”, which is used as an extended function, a value “toner save” is assigned to a quantity “character string of function” to represent the extended function, and a string “TONERSAVE” is assigned to the quantity “command character string”, which is used to instruct the printer device PT about the extended function.

In FIG. 9A, it is shown that the extended function is designated by using a “slider”, the type of figures is “integer”, the minimum possible value is “0”, the maximum possible value is “99”, and the unit (basic interval) of the figures is “1”.

Therefore, when the printer device PT transmits the printer device information to the network printer driver, it is necessary to transmit information interpretable by the network printer driver.

Further, not only the items in the extended function setting screen for setting the extended functions, but also the items in the other screens require that information compatible with the network printer driver, namely, information interpretable by the network printer driver, be created and transmitted to the network printer driver as a response.

In addition, the information interpretable by the network printer drivers has specified formats, and it is necessary that the printer device information transmitted to the respective network printer drivers as a response be expressed by formats (namely, descriptive languages) of the information interpretable by the network printer drivers, respectively. For example, PPD (PostScript Printer Description), and UPDF (Universal Printer Driver File) are printer control descriptive languages developed by Adobe Co.

Here, the PPD is a printer control descriptive language corresponding to the PostScript descriptive language. For example, samples and explanations of PPD can be found on the website http://www.gulf.or.jp/˜sera/ps/ppd.html.

The UPDF is a printer control descriptive format standardized by the Printer Working Group (PWG) (or a program, or a section) of an IEEE-related nonprofit organization “IEEE-ISTO (IEEE Industry Standards and Technology Organization)”, and is described in conformity to XML (Extendable Markup Language). The policy, activity, and products of PWG (such as UPDF) can be found on the website http://www.pwg.org/.

Therefore, in the present embodiment, the printer device PT is configured to convert registered printer device information D1 of various device functions provided in the printer device PT to the response information D3 interpretable by the network printer drivers by applying specified information generation procedures D2.

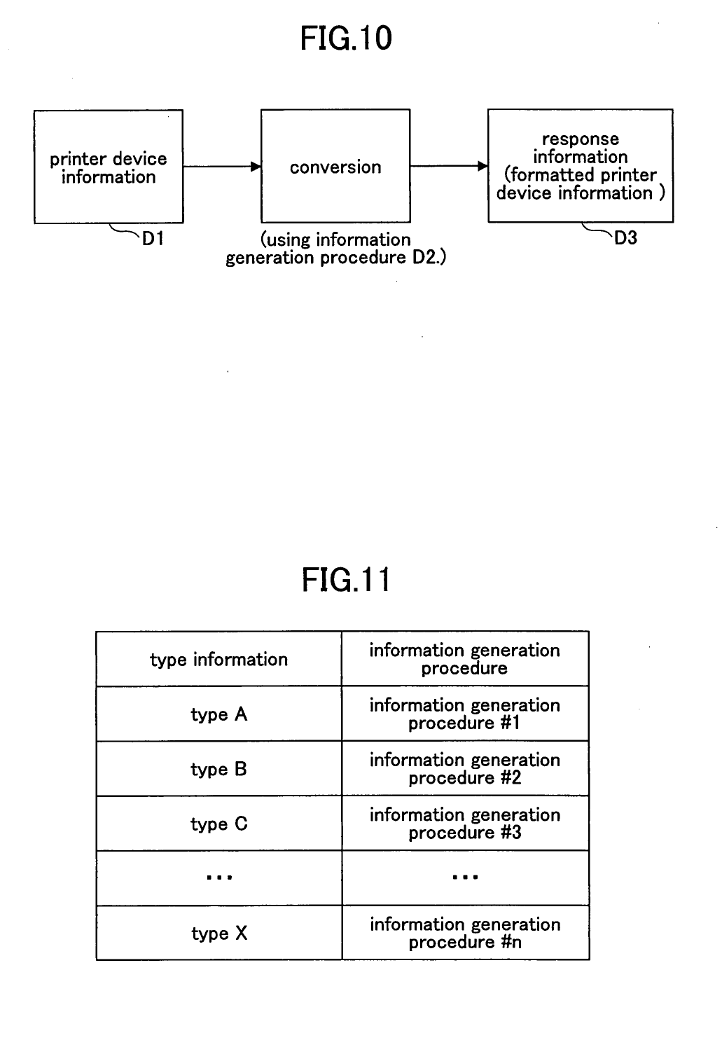

FIG. 10 is a diagram schematically illustrating operations of the printer device PT for converting the printer device information D1 of device functions of the printer device PT to the response information D3 by applying the information generation procedures D2.

Here, for example, the information generation procedures D2 are programs which convert tabulated items of the printer device information D1 to information interpretable by the corresponding network printer drivers, and further convert the resulting information to formats interpretable by the corresponding network printer drivers.

FIG. 11 illustrates an example of an information generation procedure table including the type information of the network printer drivers and the corresponding information generation procedures.

In the present embodiment, as shown in FIG. 11, the information generation procedure table is stored in the printer device PT, in which table the type information of the network printer drivers and the corresponding information generation procedures used when returning the printer device information to the network printer drivers are arranged in pairs. When a request for acquiring information is made by the network printer driver in the host device HT, the information generation procedure in correspondence to the type information of the network printer driver in the host device HT is retrieved from the information generation procedure table, the response information is created in response to the stored printer device information by applying the information generation procedure, and the response information is transmitted to the network printer driver, which made the request.

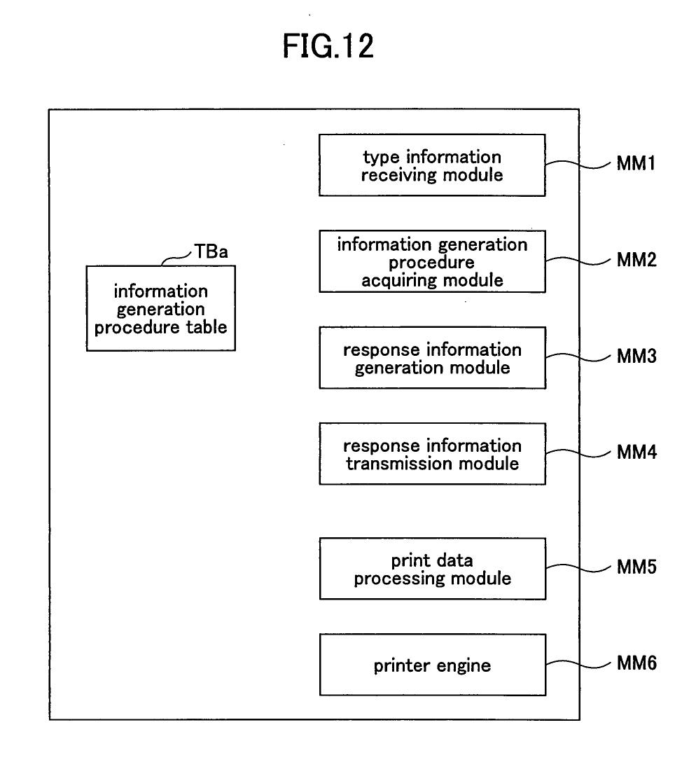

FIG. 12 is a block diagram illustrating a principal portion of a software configuration of the printer device PT.

As shown in FIG. 12, the printer device PT includes a type information receiving module MM1, an information generation procedure acquiring module MM2, a response information generation module MM3, a response information transmission module MM4, a printing data processing module MM5, and a printer engine MM6.

The type information receiving module MM1 receives the type information from the network printer drivers.

The information generation procedure acquiring module MM2 acquires the information generation procedure from the information generation procedure table TBa corresponding to the received type information receiving module MM1.

The response information generation module MM3 applies the information generation procedure obtained by the information generation procedure acquiring module MM2 to the printer device information to generate the response information.

The response information transmission module MM4 transmits the response information generated by the response information generation module MM3 to the corresponding network printer driver.

The printing data processing module MM5 converts the printing information of a print job received from the network printer driver to printing data.

The printer engine MM6 prints the printing data generated by the printing data processing module MM5.

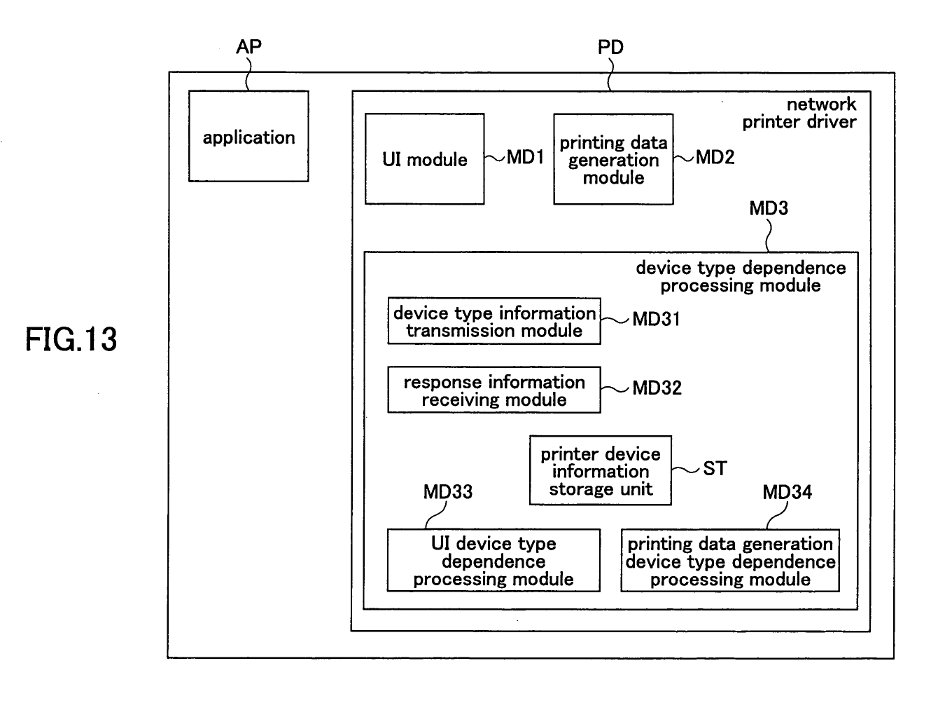

FIG. 13 is a block diagram illustrating a software configuration for printing operations in the host device HT.

As shown in FIG. 13, the host device HT includes an application AP and the network printer driver PD.

The application AP creates the printing information, and drives the printing operation by using the network printer driver PD.

The network printer driver PD includes a user interface (UI) module MD1, a printing data generation module MD2, and a device type dependence processing module MD3.

The user interface (UI) module MD1 processes the basic portion (independent of the device type) of the user interface screen.

The printing data generation module MD2 converts application data to the printing data.

The device type dependence processing module MD3 processes the portion of the network printer driver dependent on the device type.

Further, the device type dependence processing module MD3 includes a device type information transmission module MD31, a response information receiving module MD32, a printer device information storage unit ST, a user interface (UI) device type dependence processing module MD33, and a printing data generation device type dependence processing module MD34.

The device type information transmission module MD31 transmits the device type information to the host device HT.

The response information receiving module MD32 receives the response information from the host device HT, and stores the response information in a printer device information storage unit ST.

The user interface (UI) device type dependence processing module MD33 processes the portion of the user interface screen dependent on the device type.

The printing data generation device type dependence processing module MD34 generates printing data related to the device type dependent portion of the user interface.

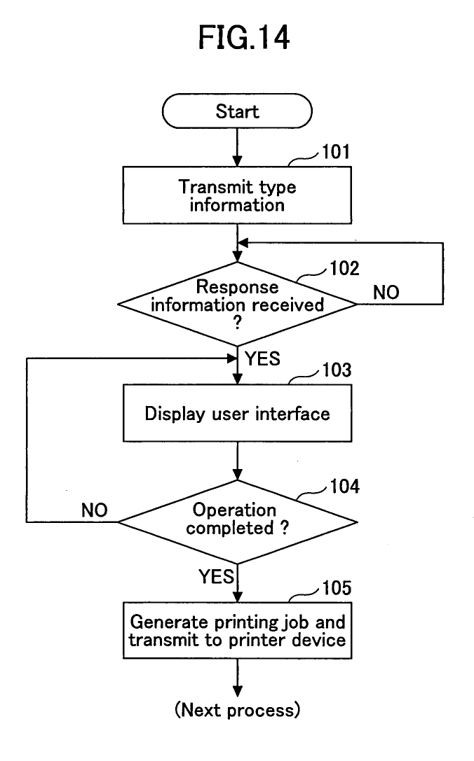

FIG. 14 is a flowchart illustrating principal operations of the network printer driver in the host device HT during a printing process.

In step 101, the host device HT transmits the type information set in the network printer driver to the printer device PT through the Local Area Network (LAN).

In step 102, the host device HT waits for the response information corresponding to the type information to be sent from the printer device PT.

In step 103, when the response information is received, the host device HT displays the above-described user interface (UI) according to the received response information.

In step 104, the host device HT waits for completion of the user's operations.

In step 105, when the user's operations are completed, the host device HT generates the print job related to the current operations, and transmits the print job to the printer device PT through the Local Area Network (LAN).

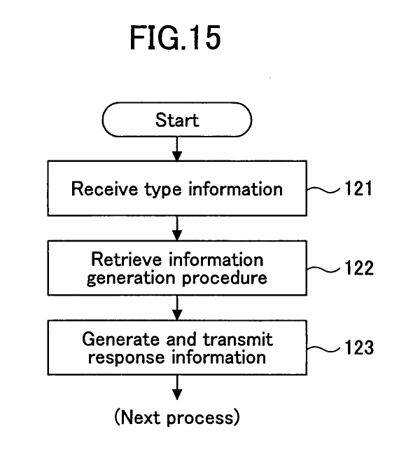

FIG. 15 is a flowchart illustrating principal operations of the printer device PT.

In step 121, the printer device PT receives the type information from the network printer driver of any one of plural host devices HT.

In step 122, the printer device PT retrieves the information generation procedure in correspondence to the type information from the information generation procedure table.

In step 123, the printer device PT generates the response information in response to the printer device information D1 of the printer device PT by applying the retrieved information generation procedure, and the response information is transmitted to the network printer driver.

As described above, in the present embodiment, since the printer device PT stores plural information generation procedures in correspondence to the type information of the network printer drivers in plural host devices HT, the printer device PT is able to appropriately generate the response information (the printer device information) corresponding to the type information from the network printer driver of any one of plural host devices HT. As a result, the network printer driver of one host device HT can appropriately constitute a user interface screen and allow the user to perform operations.

In the above embodiments, it is described that the printer device PT stores plural information generation procedures in correspondence to plural network printer drivers, but the information generation procedures may also be stored in the host devices HT. In this case, only information generation procedures corresponding to main network printer drivers are stored in the printer device PT; other information generation procedures can be obtained from the host device HT which makes the printing request. Hence, the storage capacity for storing the network printer drivers can be reduced.

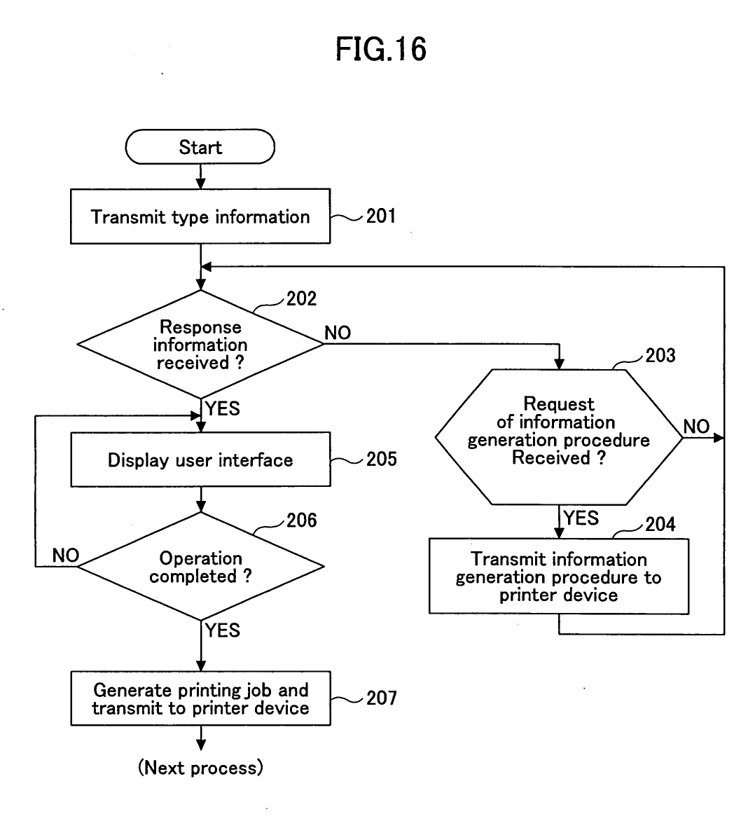

FIG. 16 is a flowchart illustrating principal operations of the network printer driver in the host device HT during a printing process when the information generation procedures are stored in the host device HT.

In step 201, the host device HT transmits the type information set in the network printer driver to the printer device PT through the Local Area Network (LAN).

In step 202, the host device HT waits for reception of the printer device information corresponding to the type information to be sent from the printer device PT as the response information.

In step 203, if the printer device information corresponding to the type information is not received from the printer device PT, the host device HT waits for a request for acquiring the information generation procedure.

In step 204, when the host device HT receives the request of acquiring the information generation procedure, the host device HT transmits the information generation procedures may stored in the host device HT previously, and then, the routine returns to step 202.

In step 205, upon reception of the response information, the host device HT displays the above-described user interface (UI) according to the received response information.

In step 206, the host device HT waits for completion of the user's operations.

In step 207, when the user's operations are completed, the host device HT generates the print job related to the current operations, and transmits the print job to the printer device PT through the Local Area Network (LAN).

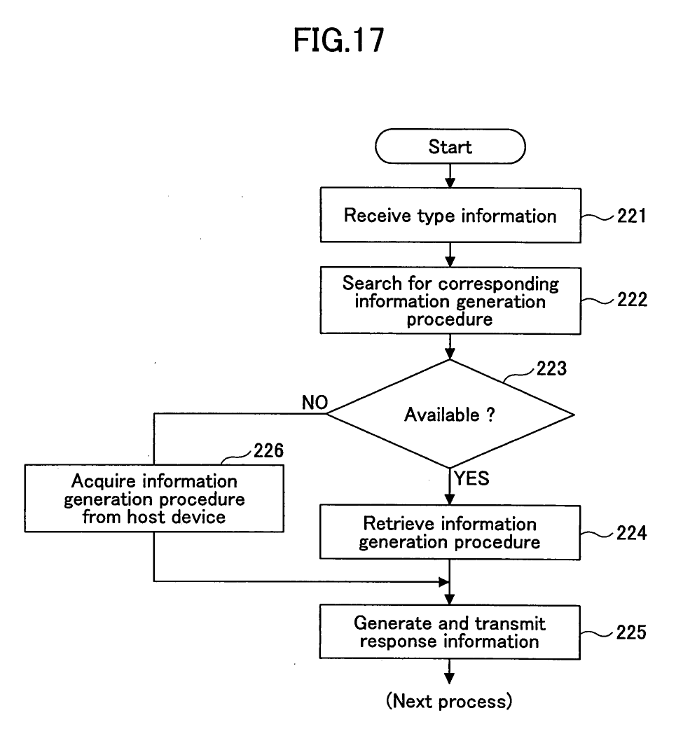

FIG. 17 is a flowchart illustrating principal operations of the printer device PT when the information generation procedures are stored in the host device HT.

In step 221, the printer device PT receives the type information from the network printer driver of any one of plural host devices HT.

In step 222, the printer device PT determines whether the information generation procedure corresponding to the received type information is stored in the information generation procedure table.

In step 223, if the corresponding information generation procedure is stored in the information generation procedure table, the routine proceeds to step 224.

If the corresponding information generation procedure is not stored in the information generation procedure table, the routine proceeds to step 226.

In step 224, the printer device PT retrieves the information generation procedure from the information generation procedure table in correspondence to the type information.

In step 225, the printer device PT generates the response information in response to the printer device information D1 of the printer device PT by applying the retrieved information generation procedure, and transmits the response information to the network printer driver.

In step 226, when it is determined that the information generation procedure corresponding to the received type information is not stored in the information generation procedure table, the printer device PT sends a request for acquiring the information generation procedure to the host device HT, and obtains the information generation procedure.

Then, similarly, in step 225, the printer device PT generates the response information in response to the printer device information D1 of the printer device PT by applying the information generation procedure obtained in step 226, and transmits the response information to the network printer driver.

In the above embodiment, it is described that when the printer device PT receives type information for which the corresponding information generation procedure is not held in the printer device PT, the printer device PT acquires the information generation procedure from the host device HT and generates the response information. Instead, the printer device PT may send the printer device information D1 to the host device HT, and the host device HT may generate the response information.

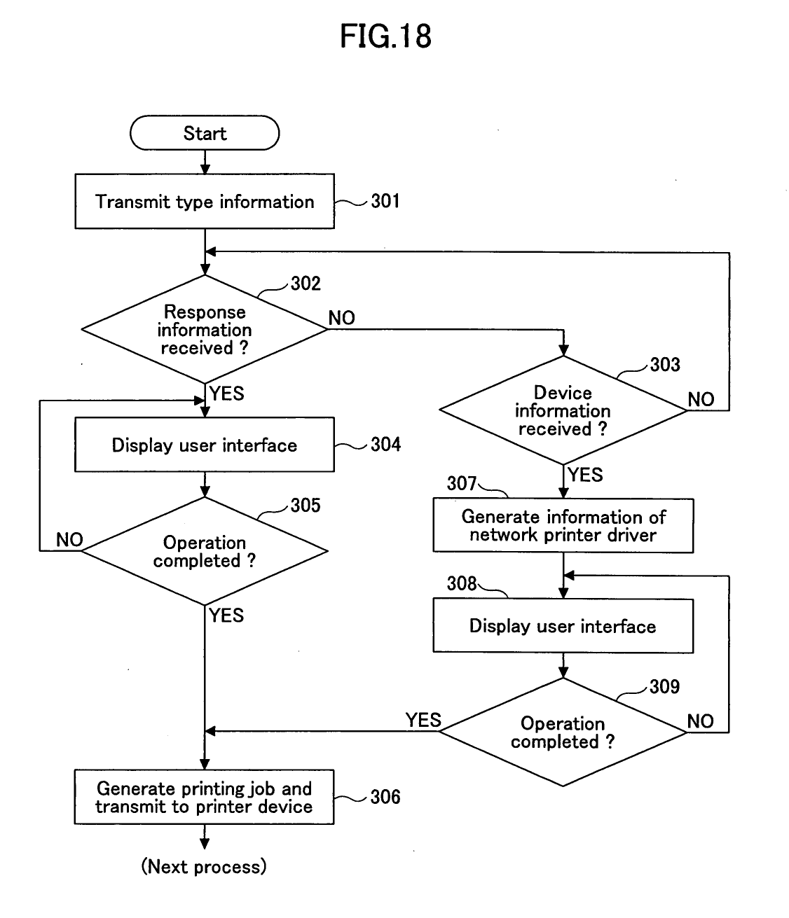

FIG. 18 is a flowchart illustrating principal operations of the network printer driver in the host device HT during a printing process when the response information is created in the host device HT.

In step 301, the host device HT transmits the type information set in the network printer driver to the printer device PT through the Local Area Network (LAN).

In step 302, the host device HT waits for reception of the response information corresponding to the type information from the printer device PT.

In step 303, if the response information corresponding to the type information is not received from the printer device PT, the host device HT waits for reception of the printer device information D1 from the printer device PT.

In step 304, if the response information corresponding to the type information is received from the printer device PT, the host device HT displays the user interface (UI) according to the received response information.

In step 305, the host device HT waits for completion of the user's operations.

In step 306, when the user's operations are completed, the host device HT generates the print job corresponding to the current operations, and transmits the print job to the printer device PT through the Local Area Network (LAN).

In step 307, when the host device HT receives the printer device information D1 from the printer device PT, the host device HT generates a piece of printer device information interpretable by the network printer drivers in response to the received printer device information D1 by applying the stored information generation procedure.

In step 308, the host device HT displays the above-described user interface (UI) according to the created printer device information.

In step 309, the host device HT waits for completion of the user's operations.

And then, similarly, in step 306, when the user's operations are completed, the host device HT generates the print job related to the current operations, and transmits the print job to the printer device PT through the Local Area Network (LAN).

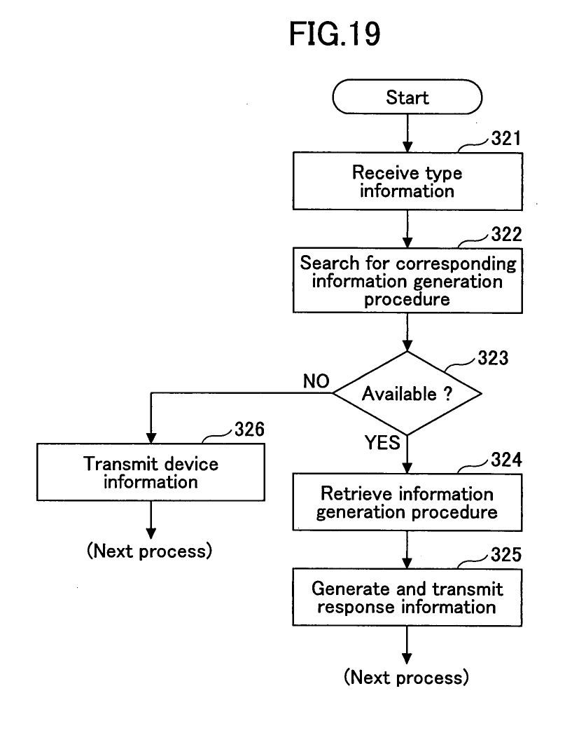

FIG. 19 is a flowchart illustrating principal operations of the printer device PT when the response information is created in the host device HT.

In step 321, the printer device PT receives the type information from the network printer driver of any one of plural host devices HT.

In step 322, the printer device PT determines whether the information generation procedure corresponding to the received type information is stored in the information generation procedure table.

In step 323, if the corresponding information generation procedure is stored in the information generation procedure table, the routine proceeds to step 324.

If the corresponding information generation procedure is not stored in the information generation procedure table, the routine proceeds to step 326.

In step 324, the printer device PT retrieves the information generation procedure from the information generation procedure table in correspondence to the type information.

In step 325, the printer device PT generates the response information in response to the printer device information D1 of the printer device PT by applying the retrieved information generation procedure, and transmits the response information to the network printer driver.

In step 326, when it is determined that the information generation procedure corresponding to the received type information is not stored in the information generation procedure table, the printer device PT retrieves the printer device information D1 stored therein and sends the printer device information D1 to the host device HT for subsequent processing.

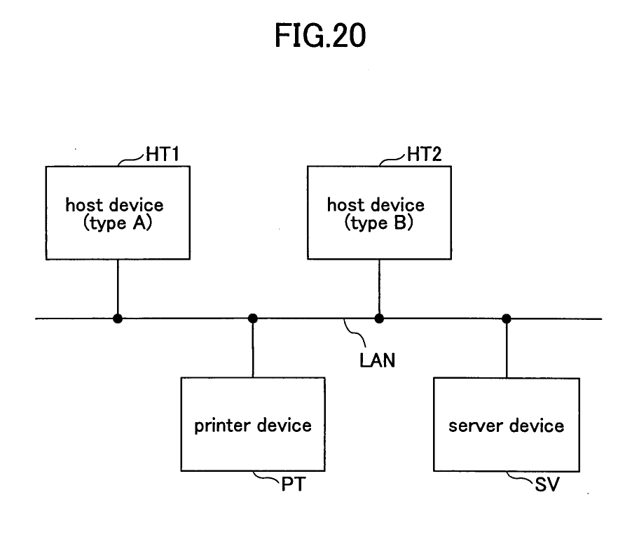

FIG. 20 is a block diagram illustrating a network printer system according to another embodiment of the present invention.

In FIG. 20, the same reference numbers are assigned to the same constituent elements as described in FIG. 1.

As shown in FIG. 20, in addition to the configuration in FIG. 1, a server device SV is connected to the Local Area Network (LAN).

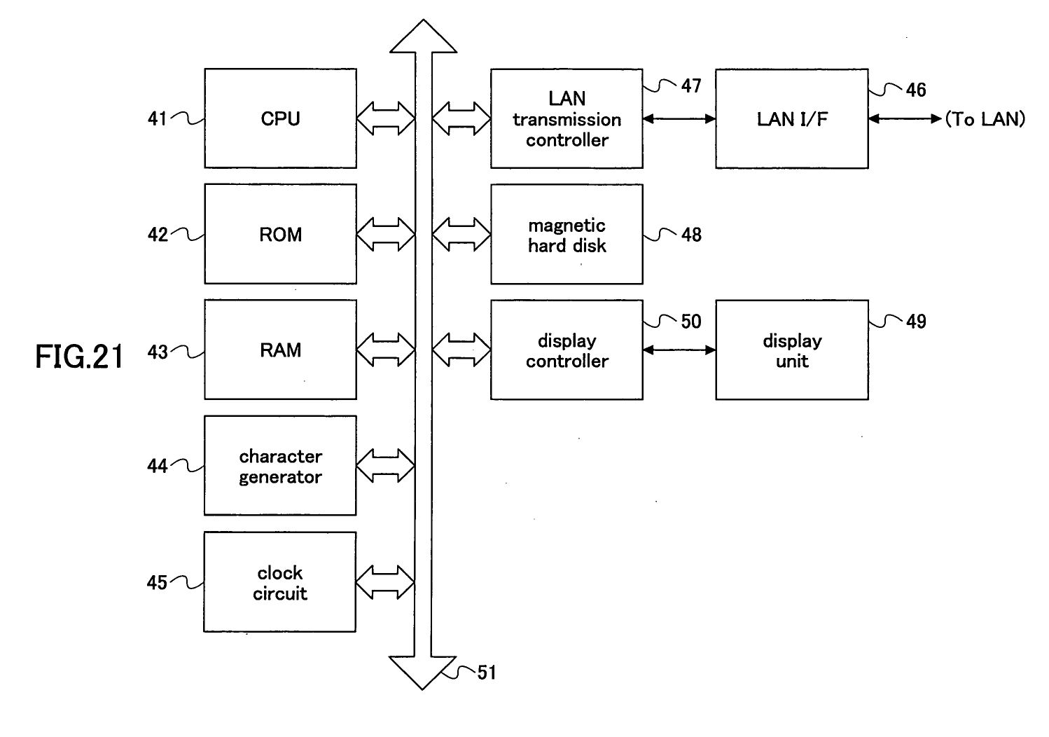

FIG. 21 is a block diagram illustrating a configuration of the server device SV.

As shown in FIG. 21, the server device SV includes a Central Processing Unit (CPU) 41, a Read-Only Memory (ROM) 42, a Randomly-Access Memory (RAM) 43, a character generator 44, a clock circuit 45, a Local Area Network interface (LAN I/F) 46, a Local Area Network transmission controller 47, a magnetic hard disk device 48, an operations display 49, a display controller 50, and a bus line 51.

The CPU 41 controls operations of the server device SV.

The ROM 42 stores various programs executed and data required when the CPU 41 is initiated.

The RAM 43 constitutes a working area of the CPU 41.

The character generator 44 generates representation data of graphic characters.

The clock circuit 45 outputs the current time.

The LAN I/F 46 connects the server device SV to a Local Area Network (LAN).

The LAN transmission controller 47 executes communication control for various protocol suites, which are used for exchanging various kinds of data with other data terminal devices.

The magnetic hard disk device 48 stores various application programs, such as database management software, system software such as an operating system, various kinds of data, such as work data, file data, and so on.

The operations display 49, also known as a console, includes a display unit and an input unit for the user to operate the server device SV.

The display controller 50 controls data exchange with the operations display 49.

The CPU 41, the ROM 42, the RAM 43, the character generator 44, the clock circuit 45, the LAN I/F 46, the LAN transmission controller 47, and the display controller 50 are all connected to the bus line 51, and data exchanges between the above components are performed primarily through the bus line 51.

In addition, in the present embodiment, corresponding to all versions of the network printer drivers used by the respective host devices HT, which are connected to the Local Area Network (LAN), the information generation procedure table (as shown in FIG. 11) is stored in the server device SV, in which table the type information of the network printer drivers and the corresponding information generation procedures are arranged in pairs.

Further, when necessary, the printer device PT acquires the information generation procedure from the server device SV, and creates response information, which is sent to the host device HT as a response.

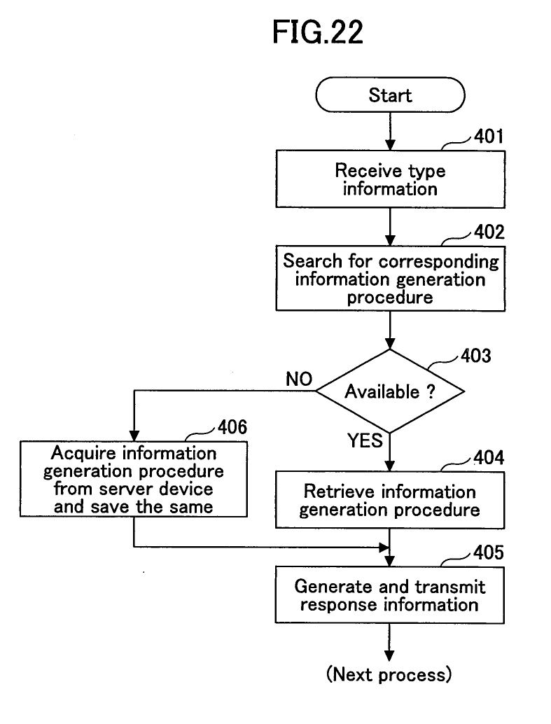

FIG. 22 is a flowchart illustrating principal operations of the printer device PT in the network printer system as shown in FIG. 20.

In step 401, the printer device PT receives the type information from the network printer driver of any one of plural host devices HT.

In step 402, the printer device PT determines whether the information generation procedure corresponding to the received type information is stored in the information generation procedure table.

In step 403, if the corresponding information generation procedure is stored in the information generation procedure table, the routine proceeds to step 404.

If the corresponding information generation procedure is not stored in the information generation procedure table, the routine proceeds to step 406.

In step 404, the printer device PT retrieves the information generation procedure from the information generation procedure table in correspondence to the type information.

In step 405, the printer device PT generates the response information in response to the printer device information D1 of the printer device PT by applying the retrieved information generation procedure, and transmits the response information to the network printer driver.

In step 406, when it is determined that the information generation procedure corresponding to the received type information is not stored in the information generation procedure table, the printer device PT sends a request for acquiring the information generation procedure corresponding to the received type information to the server device SV, and obtains the information generation procedure from the server device SV. Further, the obtained information generation procedure is stored in the information generation procedure table in pairs with the received type information; thus, elements in the information generation procedure table are increased.

Then, similarly, in step 405, the printer device PT generates the response information in response to the printer device information D1 of the printer device PT by applying the information generation procedure obtained in step 406, and transmits the response information to the network printer driver.

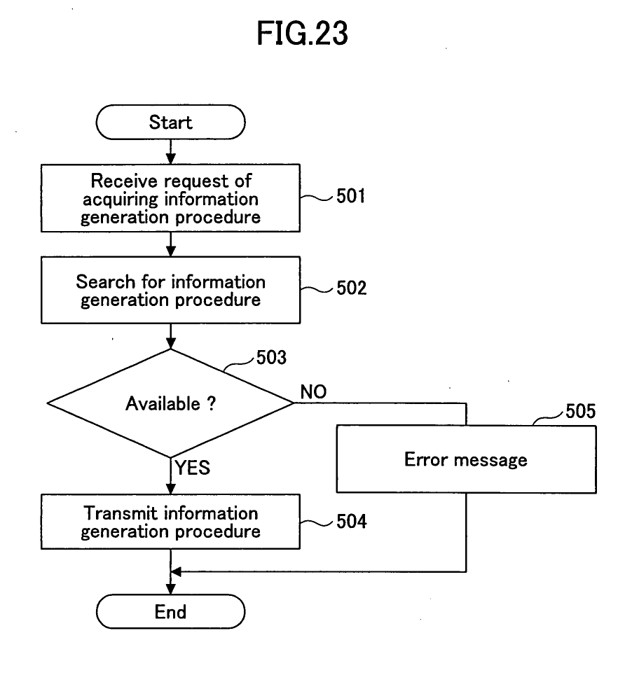

FIG. 23 is a flowchart illustrating an example of operations of the server device SV in the network printer system as shown in FIG. 20.

In step 501, the server device SV receives a request for acquiring the information generation procedure corresponding to specified type information from the printer device PT.

In step 502, the server device SV determines whether the specified type information is stored in the information generation procedure table of the printer device PT.

In step 503, if the specified type information is stored in the information generation procedure table of the printer device PT, the routine proceeds to step 504.

If the specified type information is not stored in the information generation procedure table of the printer device PT, the routine proceeds to step 505.

In step 504, the server device SV determines the corresponding information generation procedure and sends the corresponding information generation procedure to the printer device PT, which made the request for acquiring the information generation procedure.

In step 505, the server device SV sends an error message to the printer device PT, which made the request of acquiring the information generation procedure.

In this way, in the present embodiment, when it is determined that the information generation procedure corresponding to the received type information is not stored in the information generation procedure table, the printer device PT obtains the information generation procedure corresponding to the received type information from the server device SV, and adds the obtained information generation procedure to the information generation procedure table.

Here, assume the server device SV is one of services provided by the manufacturer, for example, once a new version of the network printer driver is released, the corresponding information generation procedure is registered in the server device SV, and thus, the number of the elements held in the information generation procedure table increases successively.

With this function, for example, if the printer device PT checks whether a new information generation procedure is registered in the server device SV at a constant frequency (for example, once a week, or once a month) and acquires the new information generation procedure, the printer device PT can always maintain the contents of the information generation procedure table held in the printer device PT to be the latest. This is very convenient.

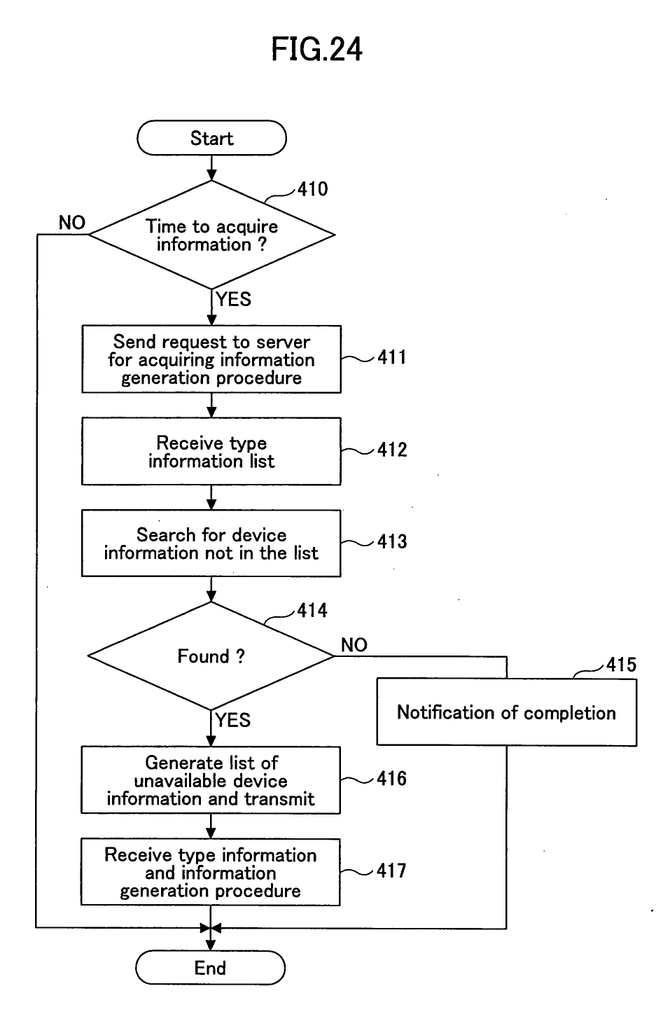

FIG. 24 is a flowchart illustrating an example of operations of the printer device PT in the network printer system as shown in FIG. 20 with the information generation procedure table being updated at any time, as described above.

In step 410, after a certain time period elapses from the last operation of acquiring new information, the printer device PT determines whether it is time to obtain new information.

If it is not time to obtain new information, the routine is finished.

If it is determined that it is time to obtain new information, the routine proceeds to step 411.

In step 411, the printer device PT sends a request for acquiring the information generation procedure.

In step 412, the printer device PT receives a list of the type information held in the information generation procedure table, which is created and sent by the server device SV.

In step 413, the printer device PT determines whether all items in the received type information list are also in the information generation procedure table stored in the printer device PT so as to find any type information item that is in the type information list but not in the information generation procedure table.

In step 414, if all of the type information items of the type information list are in the information generation procedure table, namely, there is no new information generation procedure registered in the server device SV, the routine proceeds to step 415. Otherwise, the routine proceeds to step 416.

In step 415, the printer device PT notifies the server device SV that the routine is completed.

In step 416, since it is determined that there is one or more type information items of the type information list not in the information generation procedure table, namely, there is/are new information generation procedures registered in the server device SV, the printer device PT creates an acquisition request list, which represents a list of the type information items not in the information generation procedure table, and sends the acquisition request list to the server device SV.

In step 417, in the server device SV, the information generation procedures corresponding to the type information in the acquisition request list are arranged in pairs with the type information, and the server device SV transmits the type information and the information generation procedures to the printer device PT. The printer device PT receives the transmitted type information and the information generation procedures, and registers the received type information and the information generation procedures in the information generation procedure table stored in the printer device PT.

It should be noted that the host device HT can register the information generation procedure corresponding to the network printer driver of the host device HT in the server device SV. In this case, the server device SV can be configured to hold only the minimum necessary information generation procedures.

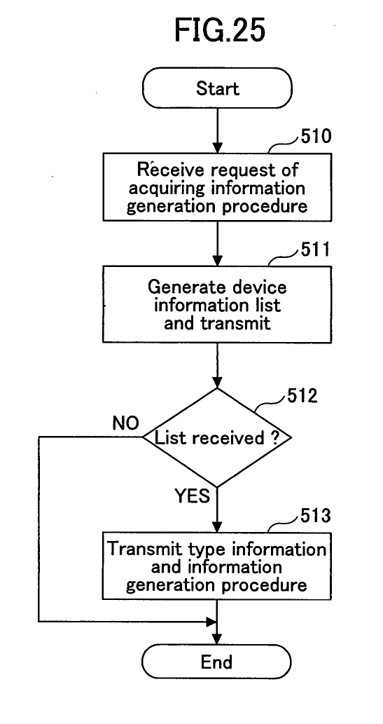

FIG. 25 is a flowchart illustrating an example of operations of the server device SV when the host device HT registers the information generation procedure corresponding to itself in the server device SV.

In step 510, the server device SV receives a request for acquiring the information generation procedure.

In step 511, the server device SV creates a list of the type information currently held in the server device SV, and sends the type information list to the printer device PT.

In step 512, the server device SV determines whether the acquisition request list is received from the printer device PT. If the server device SV does not receive the acquisition request list, the server device SV receives a completion notification to end the routine.

In step 513, when the server device SV receives the acquisition request list from the printer device PT, the server device SV retrieves the information generation procedures corresponding to one or more type information items in the acquisition request list from the information generation procedure table, arranges the retrieved information generation procedures in pairs with the type information, and transmits the type information and the information generation procedures pairs to the printer device PT.

However, since the magnetic hard disk device 48 of the server device SV can have a large capacity, for example, the printer device PT can store the response information for the network printer driver of the host device HT in the magnetic hard disk device 48.

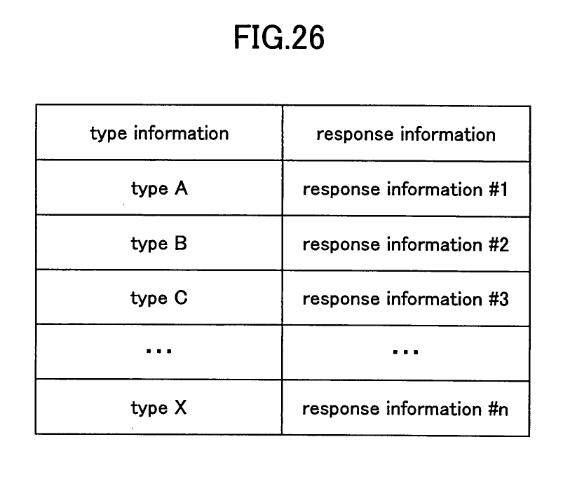

FIG. 26 is a table illustrating an example of a response information table stored in the server device SV.

With the response information table, as shown in FIG. 26, stored in the server device SV, when the response information is stored in the magnetic hard disk device 48, when the printer device PT receives a request for acquiring the printer device information from the network printer driver of the host device HT, the printer device PT does not need to create the response information by itself; instead, the server device SV may receive the response information corresponding to the type information of the network printer drivers, and send the received response information to the corresponding network printer driver.

Therefore, it is possible to reduce the processing workload of the printer device PT concerning the printer device information, and improve the response performance of the printer device PT when communicating the printer device information.

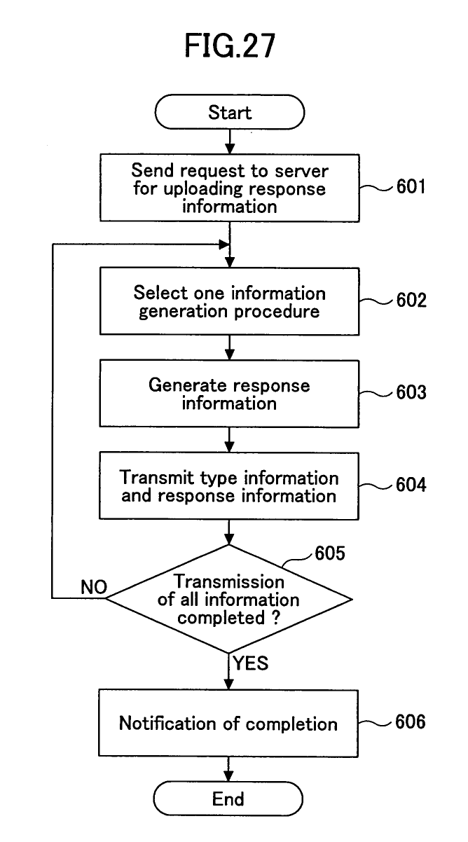

FIG. 27 is a flowchart illustrating an example of operations of the printer device PT for sending the response information to the server device SV.

It should be noted that it is preferable that this procedure be executed when there are few print jobs received by (in the queue for) the printer device PT, for example, at night.

In step 601, the printer device PT sends a request for uploading (sending) the response information to the server device SV.

In step 602, the printer device PT selects one of the information generation procedures stored in the information generation procedure table.

In step 603, the printer device PT generates the response information in response to the printer device information of the printer device PT by applying the selected information generation procedure.

In step 604, the printer device PT transmits the response information to the server device SV with the type information and the response information in pairs.

In step 605, the printer device PT determines whether transmission of the response information is completed for all of the type information items stored in the information generation procedure table.

If transmission of the response information is not completed, the routine returns to step 602 to repeat the step 602 through step 604 for the remaining type information items.

If transmission of the response information is completed, the routine proceeds to step 606.

In step 606, the printer device PT notifies the server device SV that the routine is completed.

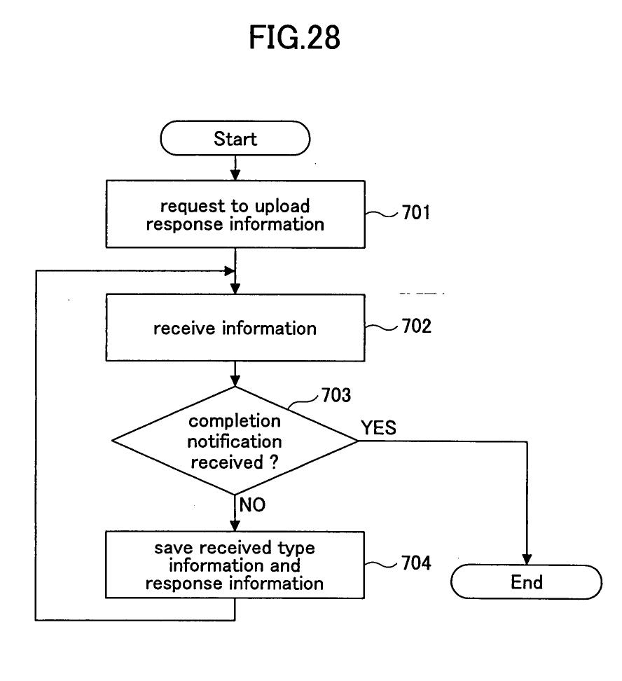

FIG. 28 is a flowchart illustrating an example of operations of the server device SV for storing the response information in the server device SV.

In step 701, the server device SV receives a request of uploading (sending) the information generation procedure from the printer device PT.

In step 702, the server device SV receives information from the printer device PT.

In step 703, the server device SV determines whether a completion notification is received. If the completion notification is received, the routine is finished. Otherwise, the routine proceeds to step 704.

In step 704, when the type information and the response information are received from the printer device PT, the server device SV stores the received type information and the response information in the response information table. Then, the routine returns to step 702 to receive subsequent information.

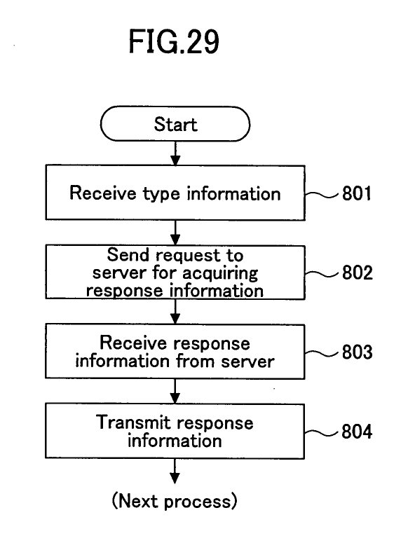

FIG. 29 is a flowchart illustrating an example of operations of the printer device PT in the present example when receiving the type information from the network printer driver of any one of the host devices HT.

In step 801, the printer device PT receives the type information from the network printer driver of any one of plural host devices HT.

In step 802, the printer device PT sends a request for acquiring the response information corresponding to the received type information to the server device SV.

In step 803, the printer device PT receives the response information from the server device SV.

In step 804, the printer device PT sends the response information to the network printer driver.

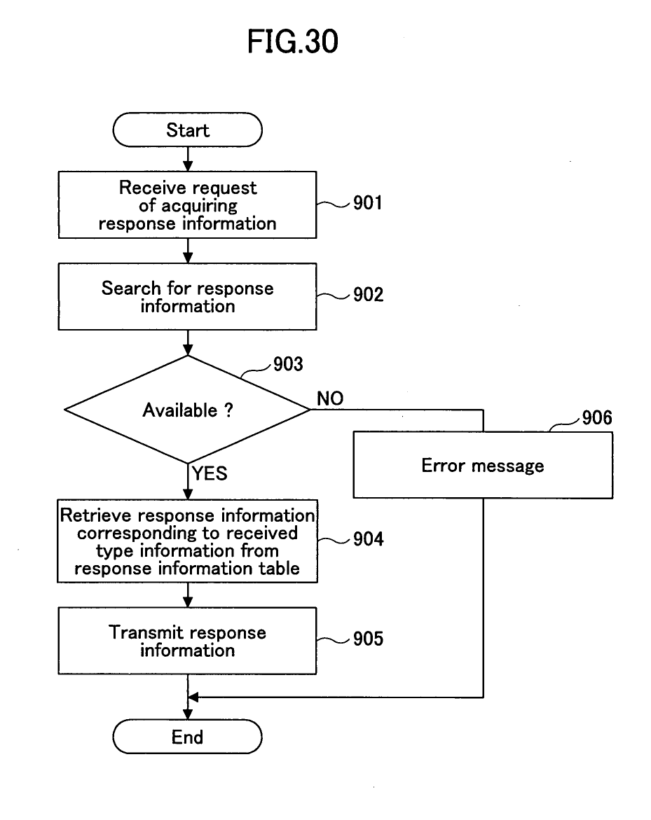

FIG. 30 is a flowchart illustrating an example of operations of the server device SV in the present example corresponding to the operations of the printer device PT in FIG. 29.

In step 901, the server device SV receives a request for acquiring the information generation procedure from the printer device PT.

In step 902, the server device SV determines whether the specified type information is stored in the response information table.

In step 903, if the specified type information is stored in the response information table, the routine proceeds to step 904.

If the specified type information is not stored in the response information table, the routine proceeds to step 906.

In step 904, when the specified type information is stored in the response information table, the server device SV retrieves the response information corresponding to the received type information from the response information table.

In step 905, the server device SV sends the retrieved response information to the printer device PT.

In step 906, when the specified type information is not stored in the response information table, the server device SV sends an error message to the printer device PT.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

For example, in the above embodiments, the network printer device PT is used as an example, but the present invention is also applicable to a multi-function peripheral, which has many other functions in addition to the network printing function.

This patent application is based on Japanese Priority Patent Applications No. 2006-054402 filed on Mar. 1, 2006, and No. 2007-013909 filed on Jan. 24, 2007, the entire contents of which are hereby incorporated by reference.

What is claimed is:

1. A printer device of a network printer system wherein the printer device is connected to a plurality of host devices for creating printing information through a network, and the printer device outputs printed materials corresponding to the printing information created by the host devices, said printer device comprising:
an information generation procedure storage unit that stores a plurality of information generation procedures in connection with type information of the host devices, each of said information generation procedures being applied when converting device information of the printer device to response information interpretable by the host devices;
a response information formation unit that receives the type information of the host devices, retrieves the information generation procedure stored in the information generation procedure storage unit in correspondence to the received type information, and converts the device information of the printer device to the response information by applying the retrieved information generation procedure; and
an information transmission unit that transmits the response information formed by the response information formation unit to the host devices.

2. The printer device as claimed in claim 1, wherein the host devices create image data to be displayed based on the received response information for a user to perform printing operations.

3. The printer device as claimed in claim 1, wherein when the information generation procedures corresponding to the type information sent from the host devices are not stored in the printer device, the printer device receives the information generation procedures corresponding to the type information from the host devices.

4. The printer device as claimed in claim 1, wherein when the information generation procedures corresponding to the type information sent from the host devices are not stored in the printer device, the printer device transmits the device information to the host devices.

5. The printer device as claimed in claim 1, wherein
a server device is provided in the network, said server device having the information generation procedure storage unit for storing the plural information generation procedures in connection with the type information of the host devices,
when receiving the type information sent from the host devices, the printer device acquires the information generation procedures in correspondence to the received type information from the server device, converts the device information of the printer device to the response information by applying the acquired information generation procedure, and transmits the response information to the host devices.
